(19) United States
(12) Patent Application Publication
(10) Pub. No.: US 2024/0154447 A1
(43) Pub. Date: May 9, 2024

(54) POWER SYSTEM

(71) Applicant: PEGATRON CORPORATION, Taipei City (TW)

(72) Inventors: Yi-Hsuan Lee, Taipei City (TW); Liang-Cheng Kuo, Taipei City (TW); Chun-Wei Ko, Taipei City (TW); Ya Ju Cheng, Taipei City (TW); Chih Wei Huang, Taipei City (TW); Ywh Woei Yeh, Taipei City (TW); Yu Cheng Lin, Taipei City (TW); Yen Ting Wang, Taipei City (TW)

(73) Assignee: PEGATRON CORPORATION, Taipei City (TW)

(21) Appl. No.: 18/457,963

(22) Filed: Aug. 29, 2023

(30) Foreign Application Priority Data
Nov. 7, 2022 (TW) 111142390

(51) Int. Cl. H02J 7/00

(52) U.S. Cl. CPC H02J 7/007182; H02J 7/00032; H02J 7/0013; H02J 7/0029

(57) ABSTRACT

A power system including a first battery pack, a second battery pack, and a power management circuit is disclosed. The first battery pack has a first end and a second end, and has a first battery capacity. The second battery pack has a third end and a fourth end. The third end is coupled to the second end of the first battery pack and provides a low battery voltage. The fourth end is grounded, the second battery pack has a second battery capacity, and the second battery capacity is greater than the first battery capacity. The power management circuit is coupled to the second battery pack to receive the low battery voltage, and provides a component operating voltage to an electronic components based on the low battery voltage.

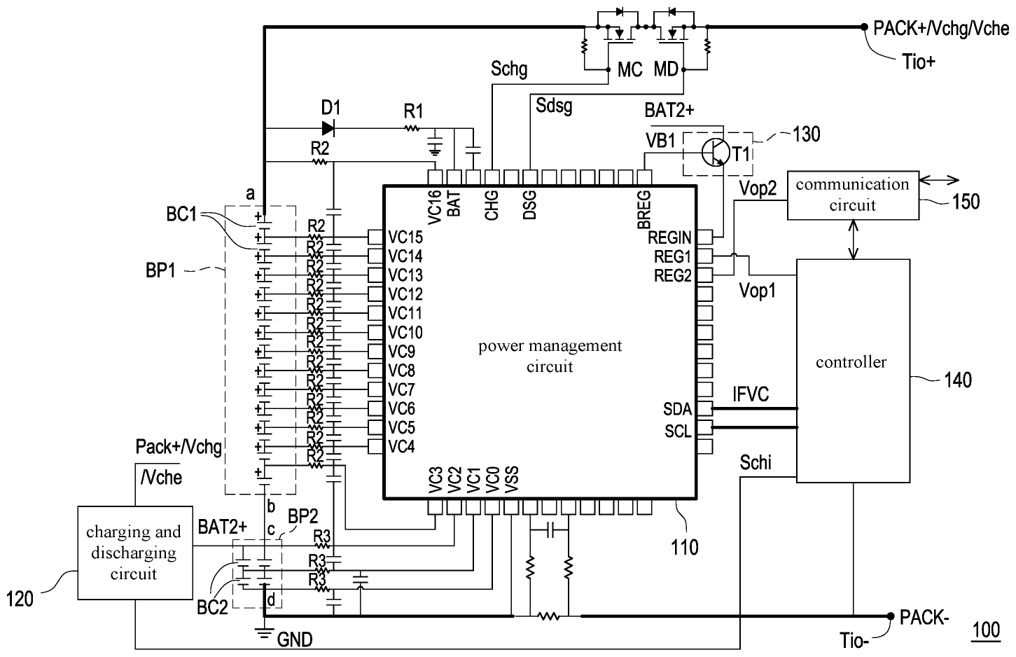

### CROSS-REFERENCE TO RELATED APPLICATION

This application claims the priority benefit of Taiwan application serial no. 111142390, filed on Nov. 7, 2022. The entirety of the above-mentioned patent application is hereby incorporated by reference herein and made a part of this specification.

### BACKGROUND

### Technical Field

This disclosure relates to a power system, and in particular to a power system having a rechargeable battery.

### Description of Related Art

Rechargeable batteries are currently used to power a variety of portable electronic devices, including laptops, mobile phones, personal digital assistants, digital music players, and wireless power tools, or to power automotive electronic devices as a standby power source. The existing battery protection board controls the power of all components by supplying the power from the battery string at the highest voltage (e.g. 19V for portable electronic devices and 58.8V for automotive electronic devices) to the power supply, which is then converted by the power conversion circuit to the voltage that can be used by the components, e.g. 5V and 3.3V. However, since the voltage used by the component is much lower than the maximum voltage of the battery string, conversion from the maximum voltage of the battery string to the voltage used by the component causes loss of voltage drop, making the battery reduce the loss of power consumption caused by unnecessary voltage drop.

### SUMMARY

The disclosure provides a power system, capable of reducing loss of voltage drop caused by voltage conversion to reduce loss of power consumption caused by voltage drop.

The power system disclosed in this disclosure includes a first battery pack, a second battery pack, and a power management circuit. The first battery pack has a first end and a second end, and has a first battery capacity. The second battery pack has a third end and a fourth end. The third end is coupled to the second end of the first battery pack and provides a low battery voltage. The fourth end is grounded. The second battery pack has a second battery capacity, and the second battery capacity is greater than the first battery capacity. The power management circuit is coupled to the second battery pack to receive the low battery voltage, and to provide a component operating voltage to an electronic component based on the low battery voltage.

Based on the above, in the power system of the embodiment of the disclosure, the power management circuit converts the low battery voltage with lower voltage to the component operating voltage for the electronic component instead of supplying a positive battery pack voltage with the highest voltage to the electronic component. As a result, the loss of power consumption caused by voltage conversion may be reduced.

To make the aforementioned more comprehensive, several embodiments accompanied with drawings are described in detail as follows.

### BRIEF DESCRIPTION OF THE DRAWINGS

The accompanying FIGURE is included to provide a further understanding of the disclosure, and is incorporated in and constitute a part of this specification. The FIGURE illustrates exemplary embodiments of the disclosure and, together with the description, serves to explain the principles of the disclosure.

The FIGURE is a schematic diagram of a power system according to an embodiment of the present disclosure.

### DESCRIPTION OF THE EMBODIMENTS

In conventional practice, an operating voltage provided to components (e.g. 3.3V or 5V) is much lower than a battery pack voltage provided by a battery pack (e.g. 58.8V or 19V), so converting the battery pack voltage to a lower operating voltage will result in loss of voltage drop. In order to reduce loss of power consumption caused by unnecessary voltage drops in the battery pack, the disclosure divides a battery string into at least two groups, and increase the number of batteries in a low-potential battery pack, i.e., increase a battery capacity of the low-potential battery pack, and then use a voltage of the low-potential battery pack to generate the operating voltage of the components. In this way, the standby time of the battery pack may be extended without depleting the battery capacity of the battery module.

The FIGURE is a schematic diagram of a power system according to an embodiment of the present disclosure. Referring to the FIGURE, in the embodiment of the disclosure, a power system 100 is, for example, a battery module of a portable electronic device (not shown), that is, the power system 100 includes, for example, a positive input/output end Tio+ and a negative input/output End Tio−. The positive input/output end Tio+ and the negative input/output end Tio− are used to provide a positive battery pack voltage PACK+ and a negative battery pack voltage PACK− to the portable electronic device (not shown).

In this embodiment, the power system 100 includes a first battery pack BP1, a second battery pack BP2, and a power management circuit 110. The first battery pack BP1 and the second battery pack BP2 are connected in series between the positive input/output end Tio+ and the negative input/output end Tio−.

Further, the first battery pack BP1 has a first end a and a second end b coupled to the positive input/output end Tio+, and has a first battery capacity. The first end a provides the positive battery pack voltage PACK+. The second battery pack BP2 has a third end c coupled to the first battery pack BP1 and a fourth end d coupled to a ground voltage node GND (i.e., ground), and has a second battery capacity. The third end c provides a low battery voltage BAT2+, the ground voltage node GND is coupled to the negative input/output end Tio− through a resistor, and the second battery capacity is greater than the first battery capacity.

The power management circuit 110 is coupled to the first battery pack BP1 and the second battery pack BP2, and receives the low battery voltage BAT2+. The power management circuit 110 provides a component operating voltage to an electronic component based on the low battery voltage BAT2+. According to the above, since the low battery voltage BAT2+ is less than the positive battery pack voltage PACK+, the loss of voltage drop caused by voltage conversion may be reduced to reduce loss of power consumption caused by the voltage drops.

In this embodiment, the power system 100 may further include a charging and discharging circuit 120, and the charging and discharging circuit 120 is coupled between the first end a of the first battery pack BP1 and the third end c of the second battery pack BP2. Moreover, the power management circuit 110 is, for example, an analog front end (AFE) chip, and has a system low voltage pin VSS, multiple voltage sensing pins VC0 to VC16, a system high voltage pin BAT, a charging protection pin CHG, a discharging protection pin DSG, a bias voltage pin BREG, a voltage regulated input pin REGIN, voltage regulated output pins REG1 and REG2, a data pin SDA, and a clock pin SCL.

In this embodiment, the system low voltage pin VSS is coupled to the ground voltage node GND. In this embodiment, the power system 100 may further include a diode D1 and a resistor R1, and the system high voltage pin BAT is coupled to the first end a of the first battery pack BP1 through the diode D1 and the resistor R1.

In this embodiment, the first battery pack BP1 is formed by connecting multiple first battery cells BC1 in series, and the second battery pack BP2 is formed by connecting multiple second battery cells BC2 in series and parallel. In this embodiment, the power system 100 may further include multiple resistors R2 and R3. The voltage sensing pins VC3 to VC16 are coupled to a contact point of the first battery cell BC1 through the multiple resistors R2, and the voltage sensing pins VC0 to VC2 are coupled to a contact point of the second battery cell BC2 through the multiple resistors R3 to detect the voltage of each of the contact point, so as to detect a first power of the first battery pack BP1, a first power of the second battery pack BP2, and a charging state and a discharging state of the first battery pack BP1 and the second battery pack BP2. The first battery pack BP1 may be composed of multiple first battery cells BC1 connected in series and in parallel, and the embodiment of the disclosure is not limited thereto.

In this embodiment, the power system 100 may further include a charging protection transistor MC and a discharging protection transistor MD. The charging protection pin CHG of the power management circuit 110 is coupled to the charging protection transistor MC, and the discharging protection pin DSG of the power management circuit 110 is coupled to the discharging protection transistor MD. The power management circuit 110 provides a charging protection signal Schg and a discharging protection signal Sdsg based on the charging state and the discharging state of the first battery pack BP1 and the second battery pack BP2. Further, the power management circuit 110 may determine whether the first battery pack BP1 and the second battery pack BP2 are overvoltage or undervoltage based on the charging state and the discharging state of the first battery pack BP1 and the second battery pack BP2, and provides the charging protection signal Schg and the discharge protection signal Sdsg accordingly.

In this embodiment, the power system 100 may further include a voltage regulating circuit 130. The bias voltage pin BREG and the voltage regulated input pin REGIN of the power management circuit 110 are coupled to the voltage regulating circuit 130. The bias voltage pin BREG is used to provide a bias voltage VB1 to the voltage regulating circuit 130, and the voltage regulated input pin REGIN is used to receive the low battery voltage BAT2+ transmitted by the voltage regulating circuit 130. In this embodiment, the power system 100 may further include a controller 140 and a communication circuit 150. In one embodiment, the communication circuit 150 may communicate with a control circuit in a portable electronic device (not shown). The power management circuit 110 provides the component operating voltage (e.g., Vop1 and Vop2) to the electronic component (e.g., the controller 140 and the communication circuit 150) based on the low battery voltage BAT2+. The component operating voltage Vop1 provided to the controller 140 is, for example, 3.3V, and the component operating voltage Vop2 provided to the communication circuit 150 is, for example, 5V, but the voltage level depends on the operation requirements of the components, and the embodiment of the disclosure is not limited thereto. In detail, the voltage regulated output pin REG1 of the power management circuit 110 is coupled to the controller 140 to provide the component operating voltage Vop1, and the voltage regulated output pin REG2 of the power management circuit 110 is coupled to the communication circuit 150 to provide the component operating voltage Vop2.

The data pin SDA and the clock pin SCL of the power management circuit 110 are coupled to the controller 140 for communication between the power management circuit 110 and the controller 140. The data pin SDA and the clock pin SCL may be used to implement the Inter-Integrated Circuit (I²C) communication protocol, but the embodiment of the disclosure is not limited thereto. Further, the controller 140 is further coupled to the charging and discharging circuit 120. The controller 140 receives power information IFVC indicating the first power of the first battery pack BP1 and a second power of the second battery pack BP2 from the power management circuit 110, and provides a reverse charging signal Schi to the charging and discharging circuit 120 based on the power information IFVC.

In this embodiment, the charging protection transistor MC has a first source/drain coupled to the first end a, a first gate receiving the charging protection signal Schg, and a second source/drain. The discharging protection transistor MD has a third source/drain coupled to the second source/drain of the charging protection transistor MC, a second gate receiving the discharging protection signal Sdsg, and a fourth source/drain coupled to the positive input/output end Tio+.

In this embodiment, the voltage regulating circuit 130 is coupled between the third end c and the power management circuit 110 for transmitting the low battery voltage BAT2+ to the power management circuit 110. The voltage regulating circuit 130 includes, for example, a bipolar junction transistor T1, and the bipolar junction transistor T1 includes a collector receiving the low battery voltage BAT2+, a base receiving the bias voltage VB1, and an emitter coupled to the power management circuit 110. The power system 100 may further include multiple capacitors disposed in the power system 100 for voltage regulation and voltage buffering.

When the power system 100 is charging, the first end a of the first battery pack BP1 receives an external charging voltage Vche from an external charger (not shown) to charge directly using the external charging voltage Vche. In addition, the charging and discharging circuit 120 may additionally charge the second battery pack BP2 using the external charging voltage Vche, so that the first battery pack BP1 and the second battery pack BP2, which have different battery power, may be substantially charged at the same time.

When the power system 100 is discharging, the first end a of the first battery pack BP1 provides the positive battery pack voltage PACK+ to the positive input/output end Tio+ through the charging protection transistor MC and the discharging protection transistor MD, and the power management circuit 110 provides the component operating voltages Vop1 and Vop2 using the low battery voltage BAT2+. When the first power of the first battery pack BP1 is less than the second power of the second battery pack BP2 and reaches a critical power, the power management circuit 110 may provide the reverse charging signal Schi to the charging and discharging circuit 120, and the charging and discharging circuit 120 provides a reverse charging voltage Vchg to the first end a using the low battery voltage BAT2+ based on the reverse charging signal Schi to charge the first battery pack BP1. The reverse charging signal Schi may be an Inter-Integrated Circuit (I²C) signal, but the embodiment of the disclosure is not limited thereto.

For example, the overall system is designed for a battery capacity of 15 ampere hours (Ah) of the first battery pack BP1 and an increased number of batteries in parallel in the second battery pack BP2 to increase the battery capacity of the second battery pack BP2 to 20 ampere hours. If the standby power consumption of the portable electronic device (not shown) is 10 milliamps (mA) and its standby time is 1500 hours (h), the battery capacity of the original design will be only 10 ampere hours. However, the standby time of the power system 100 of the embodiment of the disclosure (with the addition of the battery of the second battery pack BP2) may be extended to 2000 hours, and only the power of the second battery pack BP2 is used for the first 500 hours, while the battery power of the first battery pack BP1 does not decay, that is, the battery power of the first battery pack BP1 of the original design of 15 ampere hours is maintained.

In this embodiment, the first battery pack BP1 and the second battery pack BP2 are a combination of battery packs with unbalanced capacity, but the power balance may be achieved by controlling the charging and discharging circuit 120. The following example is illustrated with the battery capacity of the first battery pack BP1 being 15 ampere hours and the battery capacity of the second battery pack BP2 being increased to 20 ampere hours.

When the entire battery pack (the first battery pack BP1 and the second battery pack BP2) is at 0 ampere hours, a charging function in the charging and discharging circuit 120 is activated to charge the second battery pack BP2 with a current of 5 amps, and an external charger (not shown) in the system is used to provide 15 amps to charge the entire battery pack (the first battery pack BP1 and the second battery pack BP2). In this way, a charging current of the first battery pack BP1 may be maintained at 15 amps, and the charging current of the second battery pack BP2 may be maintained at 20 amps, which are expected to be fully charged at the same time.

When the battery power of the second battery pack BP2 is 5 ampere hours and the battery power of the first battery pack BP1 is 0 ampere hours, they may be charged by using only 15 amps provided by the external charger (not shown) in the system, and it is estimated that they may be fully charged at the same time.

When the battery power of the second battery pack BP2 is 7 ampere hours and the battery power of the first battery pack BP1 is 0 ampere hours, in addition to charging with 15 amps provided by the external charger (not shown), the boost load function in the charging and discharging circuit 120 is turned on to reverse charge the battery power of the second battery pack BP2 (i.e., the low battery voltage BAT2+) to the positive input/output end Tio+ of the entire battery pack, i.e., to provide the reverse charging voltage Vchg to the positive input/output end Tio+ to charge the first battery pack BP1 until the battery power of the first battery pack BP1 is balanced with the battery power of the second battery pack BP2, i.e. the difference between the battery power of the first battery pack BP1 and the battery power of the second battery pack BP2 is about a default difference (e.g. 5 ampere hours), then the boost load function is turned off.

When the battery power of the second battery pack BP2 is 10 ampere hours and the battery power of the first battery pack BP1 is 5 ampere hours, they may be charged by using only 15 amps provided by the external charger (not shown) in the system, and it is estimated that they may be fully charged at the same time.

When the battery power of the second battery pack BP2 is 18 ampere hours and the battery power of the first battery pack BP1 is 15 ampere hours, the charging protection transistor MC of the power system 100 is turned off so that the external charger (not shown) cannot charge the first battery pack BP1, and the charging function in the charging and discharging circuit 120 continues to charge the second battery pack BP2.

The above charging and discharging states are examples for illustration, and at least one of the voltage, current, temperature, and battery power of the first battery pack BP1 and the second battery pack BP2 may be monitored by the controller 140. The controller 140 is fine-tuned to control the charging of the first battery pack BP1 and the second battery pack BP2 based on the results of the monitoring.

Based on the above, the embodiment of the disclosure changes the power input originally provided to the electronic component from the positive battery pack voltage PACK+ with the highest voltage in the battery pack (i.e., the first battery pack BP1 and the second battery pack BP2) to the second battery pack BP2 with a low potential, and increases the battery capacity of the second battery pack BP2 to offset the loss of the second battery pack BP2 due to the power consumption of external components, and thus increase the standby time of the overall system. Further, the charging and discharging circuit 120 may be added to the power system 100 for the second battery pack BP2, so that the second battery pack BP2 may be additionally charged, and when the battery power of the second battery pack BP2 is greater than the battery power of the first battery pack BP1 during charging, a reverse boost discharging may be performed to balance the battery power of the second battery pack BP2 and the battery power of the first battery pack BP1.

To sum up, in the power system of the embodiment of the disclosure, the power management circuit converts the low battery voltage with lower voltage to the component operating voltage provided to the electronic component instead of the positive battery pack voltage with the highest voltage. Therefore, the voltage drop of the component operating voltage caused by voltage conversion may be reduced to reduce the loss of power consumption caused by voltage drop.

It will be apparent to those skilled in the art that various modifications and variations can be made to the disclosed embodiments without departing from the scope or spirit of the disclosure. In view of the forthcoming, it is intended that the disclosure covers modifications and variations provided that they fall within the scope of the following claims and their equivalents.

What is claimed is:

1. A power system comprising:
a first battery pack having a first end and a second end, and having a first battery capacity;
a second battery pack having a third end and a fourth end, wherein the third end is coupled to the second end of the first battery pack and provides a low battery voltage, the fourth end is grounded, the second battery pack has a second battery capacity, and the second battery capacity is greater than the first battery capacity; and
a power management circuit coupled to the second battery pack to receive the low battery voltage, and to provide a component operating voltage to an electronic component based on the low battery voltage.

2. The power system according to claim 1, wherein the first end receives an external charging voltage from an external charger, and the power system further comprises:
a charging and discharging circuit coupled between the first end of the first battery pack and the third end of the second battery pack, wherein the charging and discharging circuit is adapted to charge the second battery pack based on the external charging voltage, and to provide a reverse charging voltage to the first end based on the low battery voltage to charge the first battery pack when a first power of the first battery pack is less than a second power of the second battery pack and reaches a critical power.

3. The power system according to claim 2, wherein the power management circuit is further coupled to the first battery pack to detect the first power of the first battery pack and the second power of the second battery pack.

4. The power system according to claim 3 further comprising:
a controller coupled to the power management circuit and the charging and discharging circuit, wherein the controller is adapted to receive power information indicating the first power and the second power from the power management circuit, and provides a reverse charging signal to the charging and discharging circuit based on the power information,
wherein the charging and discharging circuit is adapted to provide the reverse charging voltage based on the reverse charging signal.

5. The power system according to claim 2, wherein the first battery pack is charged using the external charging voltage.

6. The power system according to claim 1 further comprising:
a voltage regulating circuit coupled between the third end of the second battery pack and the power management circuit, and configured to transmit the low battery voltage to the power management circuit.

7. The power system according to claim 6, wherein the voltage regulating circuit comprises a bipolar junction transistor, the bipolar junction transistor comprises a collector receiving the low battery voltage, a base receiving a bias voltage, and an emitter coupled to the power management circuit.

8. The power system according to claim 1 further comprising:
a charging protection transistor having a first source/drain coupled to the first end, a first gate receiving a charging protection signal, and a second source/drain; and
a discharging protection transistor having a third source/drain coupled to the second source/drain of the charging protection transistor, a second gate receiving a discharging protection signal, and a fourth source/drain coupled to a positive input/output end,
wherein the power management circuit is further coupled to the first battery pack, the charging protection transistor and the discharging protection transistor, to detect a charging state and a discharging state of the first battery pack and the second battery pack to provide the charging protection signal and the discharging protection signal based on the charging state and the discharging state.

9. The power system according to claim 1, wherein the electronic component comprises at least one of a controller and a communication circuit.

10. The power system according to claim 1, wherein the power management circuit comprises an analog front end chip.
